(19) United States
(12) Patent Application Publication
(10) Pub. No.: US 2021/0117929 A1
(43) Pub. Date: Apr. 22, 2021

(54) GENERATING AND ADAPTING AN AGENDA FOR A COMMUNICATION SESSION

(71) Applicant: MICROSOFT TECHNOLOGY LICENSING, LLC, Redmond, WA (US)

(72) Inventors: Hannah Rebecca LEWBEL, Kirkland, WA (US); Isabel Sophie SHARP, Seattle, WA (US); Adam Michael GLEISNER, Seattle, WA (US); Lindsey CONWAY, Seattle, WA (US); Clea ALLINGTON, Seattle, WA (US); Minu GEORGE, Sammamish, WA (US); Samantha Robbie COURTS, Bellevue, WA (US); Margaret Arlene GROUNDS, Kirkland, WA (US); Scott H.W. SNYDER, Seattle, WA (US); Nassr ALBAHADLY, Redmond, WA (US)

(21) Appl. No.: 16/660,763

(22) Filed: Oct. 22, 2019

(51) Int. Cl. G06Q 10/10

(52) U.S. Cl. CPC G06Q 10/1095

(57) ABSTRACT

Technologies are disclosed that enable a computing system to adapt an agenda for a communication session so the agenda more accurately reflects the actual course of discussion during the communication session. A graphical user interface is configured to display aspects of the agenda so that participants of the communication session are aware of topics being discussed or to be discussed, as well as the time initially assigned to discuss the topics. The agenda can adapt depending on the course of discussion during the communication session. That is, agenda items can be removed, reordered, added, extended, shortened, etc. based on an analysis of actual topics being discussed during the communication session and the timing of such discussions. The agenda can additionally or alternatively encourage participation and inclusivity. For instance, the agenda can inform participants of behavior-related goals associated with participation and inclusivity.

### BACKGROUND

Technologies that enable group collaboration, such as a videoconference meeting, provide an opportunity for multiple users to converse about different topics and/or share information. In some scenarios, there may be an agenda generated for a group collaboration. For instance, an organizer of a meeting may outline topics to discuss, and assign an amount of time to discuss each topic. Often times, the actual course of discussion during the group collaboration does not adhere to the original order of topics and/or an amount of time assigned to the discussion of an individual topic in the agenda. Consequently, the original agenda generated for the group collaboration does not accurately reflect the actual order of the topics discussed and/or the actual amounts of time the topics were discussed during the group collaboration.

It is with respect to these and other considerations the disclosure made herein is presented.

### SUMMARY

The techniques disclosed herein are configured to adapt an agenda for a communication session so the agenda more accurately reflects the actual course of discussion during the communication session. A communication session may include a video conference, a telephonic conference, a collaborative real-time workspace, a webcast, a web meeting, a group chat, or any other platform that enables a meeting or group collaboration. A communication session can include participants joining remotely via conferencing or similar technologies and/or participants that are co-located (e.g., the participants are in a conference room).

The system described herein is configured to display, in a graphical user interface, aspects of an agenda in association with a communication session so that the participants of the communication session are aware of topics being discussed or to be discussed, as well as the time initially assigned to discuss the topics. Consequently, the agenda can include a sequence of agenda items, and each agenda item may be assigned a time segment to discuss a topic (e.g., the first ten minutes of a one hour meeting, the last fifteen minutes of a one hour meeting, etc.). Since each agenda item is associated with at least one topic, an “agenda item” and a “topic” may be used interchangeably in this disclosure.

A single user interface (UI) of a group collaboration application may provide both the content of the communication session and the content of the agenda. For example, upon commencement of the communication session, the system can display information associated with all the agenda items (e.g., titles of the agenda items, time periods initially assigned to the agenda items, etc.), information associated with an agenda item currently being discussed (e.g., a title of the current agenda item, a time period initially assigned to the current agenda item, etc.), and/or an amount of assigned time remaining to discuss an agenda item currently being discussed. The agenda can be pulled in from a scheduling object (e.g., a calendar appointment) or another external source. Alternatively, the agenda can be automatically created by the system based on a type of communication session (e.g., a team meeting that re-occurs on a weekly basis and that has a predetermined set of topics typically discussed in each meeting).

The system can adapt (e.g., change, modify, update, adjust, etc.) an agenda depending on the course of discussion during the communication session. That is, agenda items can be removed, reordered, added, extended, shortened, etc. based on an analysis of actual topics being discussed during the communication session and the timing of such discussions (e.g., the length of time a topic is discussed). For example, if the flow of discussion causes a topic associated with an agenda item to be discussed in the communication session earlier than initially scheduled in the agenda, the system can detect this adaptation and reorder the agenda items to reflect the flow of discussion. In another example, if the discussion of a topic extends beyond an assigned time, then the system can recognize this time extension and adapt the agenda to account for the time extension. In some scenarios, time assigned to an agenda item that follows a current agenda item can be shortened when the current agenda item is extended. This ensures participants' schedules are respected and the communication session ends at a scheduled time.

An adaptation to the agenda can be implemented automatically by the system or can be implemented based on user input. For instance, an authorized participant, such as an organizer of the communication session, may be prompted to approve the adaptation. An “organizer” can include a meeting host, a meeting owner, a device owner, or any other type of participant in the communication session who has a greater level of direct or indirect control over the behavior of software and/or hardware implementing the communication session. Moreover, aspects of the agenda can be visually displayed to the participants so they can see an adaptation in real-time.

In some implementations, the system is configured to use a timer to track an actual amount of time an agenda item is discussed and compare the actual amount of time to an assigned amount of time initially associated with the agenda item. When there is a difference, the system can adapt the agenda. Further, the system can use the adapted agenda as the initial agenda for another communication session. The other communication session may be one that is part of a series of re-occurring meetings in which a predetermined set of topics is discussed. Consequently, the system learns, over time, an amount of time to assign to a particular agenda item in an agenda for subsequent or next meetings.

Additionally, the system can generate and distribute a summary of the communication session based on an adapted agenda. Accordingly, the summary can show the actual order of agenda items discussed and/or the actual amounts of time spent discussing the agenda items. The summary can be automatically sent to the participants of the communication session in an email or another form of communication after the communication session is over. The summary of the communication session can further include: content that was shared with respect to an agenda item, objects that were drawn on a digital whiteboard with respect to an agenda item, actionable tasks that need to be performed with respect to an agenda item, contentious points of discussion with respect to an agenda item, identifications of participants that discussed an agenda item, and so forth.

In various configurations described herein, an agenda item can be associated with metadata indicating whether an assigned amount of time to discuss the agenda item can be extended. If the assigned amount of time to discuss the agenda item can be extended, then the agenda item may be referred to as an extendable agenda item. If the assigned amount of time to discuss the agenda item cannot be extended, then the agenda item may be referred to as a restricted agenda item.

An organizer, or another participant to the communication session, can designate an agenda item as extendable or restricted based on a level of importance of a topic. For instance, time extensions may more likely be allowed to discuss more important topics while the organizer may wish to ensure that discussions of less important topics are not extended beyond an assigned amount of time. Additionally or alternatively, an organizer can designate an agenda item as extendable or restricted based on whether a topic can be discussed in a next communication session (e.g., the next weekly team meeting). For example, a topic may be part of a standard set of topics discussed in a team meeting each week. In another example, a time extension may more likely be allowed to discuss a topic associated with an event that is scheduled to occur within a predetermined time period (e.g., the next day, the coming week, etc.). However, the time extension may not be allowed to discuss a topic associated with an event that is scheduled outside the predetermined time period (e.g., a month out) because the team will be able to discuss the topic in greater detail during the next weekly team meeting.

The system can be configured to generate and display a notification when a predetermined amount of time remains for a time segment assigned to a current agenda item (e.g., one minute for discussion remains, two minutes for discussion remains, etc.). Moreover, the notification can inform participants whether the current agenda item is extendable or restricted. Consequently, the participants know, without having to ask, whether the organizer is allowing for an extended discussion of an agenda item or whether the organizer would like to limit the discussion of an agenda item to a particular amount of time.

In further configurations described herein, the agenda can encourage participation and inclusivity. For instance, the agenda can inform participants of behavior-related goals associated with participation and inclusivity. The behavior-related goals can be determined based on data aggregation from previous communication sessions with the same or similar participants. That is, a system can identify a speaker, track how many times a particular user spoke, detect user actions (e.g., gestures, facial expressions, direction of gaze, etc.), and so forth. In one specific example, a behavior-related goal can indicate that bad behavior (e.g., user interruptions) from a previous communication session is to be removed from the current communication session. In another specific example, a behavior-related goal can encourage participants to share ideas since the participants were generally silent during the previous communication session. In yet another specific example, a behavior-related goal can encourage a first group of participants (e.g., sales people) to allow another group of participants (e.g., accounting people) to share ideas since the first group had the opportunity to share its ideas during a previous communication session.

A behavior-related goal may be applicable to all the agenda items in the agenda, to a subset of agenda items in the agenda, or to a specific agenda item in the agenda. As a communication session progresses and an agenda item is discussed, the system described herein may be configured to collect data associated with participation in the communication session and analyze the data to determine that a behavior-related goal has not been satisfied. For instance, the system can determine that: a threshold number of people have not spoken, a threshold number of people have not shared a screen, a threshold number of people have not drawn an object on a whiteboard, a number of interruptions exceeds a minimum allowed number of interruptions, etc. The system can then generate a reminder for display, the reminder notifying a participant to the communication session that the behavior-related goal has not been satisfied. In one embodiment, the participant is the organizer, and thus, the organizer can take steps to ensure that efforts are made to improve participation and inclusivity with respect to the behavior-related goal.

Consequently, the system described herein adapts an agenda so it more accurately reflects an actual collaboration experience. The techniques presented in this disclosure can save computing resources, such as memory resources, processing resources, and networking resources. Other technical benefits beyond those mentioned specifically can also be realized through implementations of the disclosed subject matter. Among other technical benefits, the techniques disclosed herein can reduce utilization of computing resources by automatically generating and adapting an agenda. This can reduce the utilization of computing resources like processor cycles, memory, network bandwidth, and power.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an architecture for providing an adapted agenda for a communication session.

FIG. 2 shows an illustrative user interface for displaying information associated with an agenda during a communication session.

FIG. 3 shows an illustrative user interface in which it is determined that a topic currently being discussed during a time segment assigned to an agenda item is associated with another agenda item in the sequence of agenda items.

FIG. 4A shows an illustrative user interface in which an agenda item is removed when the discussion of two agenda items is sufficiently covered within a time segment assigned to a single agenda item. In this scenario, a total length of the communication session is shortened.

FIG. 4B shows an illustrative user interface in which an agenda item is removed and a time segment assigned to a current agenda item is extended to accommodate the discussion of two agenda items. In this scenario, a total length of the communication session remains the same.

FIG. 5 shows an illustrative user interface in which an agenda item discussed in association with a current agenda item is moved to a position in the agenda that immediately follows the current agenda item.

FIG. 6 shows an illustrative user interface in which a time segment assigned to the current agenda item is extended while a time segment assigned to another agenda item discussed in association with the current agenda item is shortened.

FIG. 7 shows an illustrative user interface in which agenda items can be switched.

FIG. 8 shows an illustrative user interface in which a request to approve an adaptation to an agenda can be sent to an authorized person.

FIG. 9 illustrates an example of how an adapted agenda can be used to generate a summary of the communication session, as well as an original agenda for a next communication session.

FIG. 10 shows an illustrative user interface in which a notification indicating that a current agenda item is designated as an extendable agenda item can be displayed.

FIG. 11 shows an illustrative user interface in which a notification indicating that a current agenda item is designated as a restricted agenda item can be displayed.

FIG. 12A shows an illustrative user interface in which a request for approval to extend a time period for a current agenda item is displayed.

FIG. 12B shows an illustrative user interface in which a group request for approval to extend a time period for a current agenda item is displayed.

FIG. 13 shows an illustrative user interface in which behavior-related goals can be displayed.

FIG. 14 shows an illustrative user interface in which a notification indicating that a behavior-related goal has not been satisfied can be displayed.

FIG. 15 shows an illustrative user interface for displaying aspects of an adapted agenda in an example video collaboration application.

FIG. 16 is an illustrative user interface for displaying aspects of an adapted agenda in an example inking/drawing collaboration application.

FIG. 17 is a flow diagram showing aspects of a process for generating and displaying an adapted agenda.

FIG. 18 is a flow diagram showing aspects of a process for generating and displaying a notification indicating whether an agenda item is an extendable agenda item or a restricted agenda item.

FIG. 19 is a flow diagram showing aspects of a process for generating and displaying a notification indicating whether a behavior-related goal has been satisfied.

FIG. 20 is a computer architecture diagram illustrating an illustrative computer hardware and software architecture for a computing system capable of implementing aspects of the techniques and technologies presented herein.

FIG. 21 is a diagram illustrating a distributed computing environment capable of implementing aspects of the techniques and technologies presented herein.

### DETAILED DESCRIPTION

This disclosure provides techniques for adapting an agenda for a communication session so the agenda more accurately reflects the actual course of discussion during the communication session. A graphical user interface is configured to display aspects of the agenda so that participants of the communication session are aware of topics being discussed or to be discussed, as well as the time initially assigned to discuss the topics. The agenda can adapt depending on the course of discussion during the communication session. That is, agenda items can be removed, reordered, added, extended, shortened, etc. based on an analysis of actual topics being discussed during the communication session and the timing of such discussions. The agenda can additionally or alternatively encourage participation and inclusivity. For instance, the agenda can inform participants of behavior-related goals associated with participation and inclusivity.

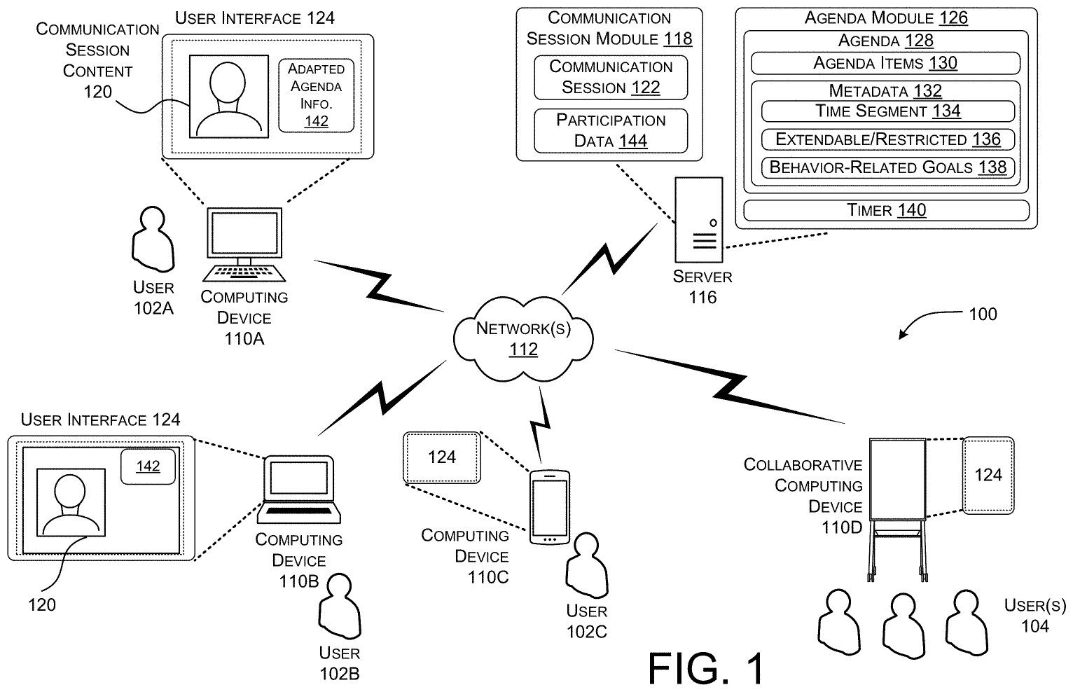

FIG. 1 illustrates an architecture 100 for providing an adapted agenda for a communication session. This architecture 100 shows an example communication session that includes multiple users 102A-102C using individual devices, as well as a group of users 104 using a collaborative computing device. A user may be referred to herein as a participant to the communication session. Note that a communication session may include any number of participants (e.g., two, five, ten, fifty, hundreds, thousands, etc.).

The participants in the communication session access the communication session through their respective computing devices 110A-110D (referred to collectively as “computing devices 110” or individually as a “computing device 110”) that are configured with an appropriate communication application. The computing devices 110A-110D may be any type of computing device such as, but not limited to, desktop computers, thin clients, laptop computers, tablets, smartphones, and the like. The architecture 100 described here is not limited to use with any specific types of computing devices. One or more of the computing devices 110 may additionally or alternatively be a collaborative computing device 110D such as a large-screen digital whiteboard that can be used by multiple people simultaneously. A digital whiteboard can present whiteboard objects such as, but not limited to, handwriting or hand-drawn images such as digital ink created using a digital pen or touchscreen.

Network(s) 112 provide a communicative connection between all of the computing devices 110. The network(s) 112 may be implemented as any one or more types of communications networks such as the Internet, a Local Area Network (LAN), a Wide Area Network (WAN), a mesh network, a peer-to-peer network, a cellular network, etc. The network(s) 112 may use both wired and wireless protocols for carrying data.

In some implementations, the network(s) 112 may connect the computing devices 110 to a server 116. The server 116 may be a single computing device or multiple computing devices such as a rack of servers. In this disclosure, the server 116 may also represent a “cloud” resource that includes multiple discrete processing, storage, and networking resources which may be distributed across multiple physically separate locations. In various examples described herein, the server 116 may be referred to as a system implementing the disclosed techniques.

The server 116 may provide resources to implement, manage, and maintain the communication session. For example, the server 116 may include a communication session module 118 that coordinates the layout and distribution of content 120 of a communication session 122. For instance, the communication session module 118 can be configured to generate and cause display of a user interface 124 on the computing devices 110. The user interface 124 includes the communication session content 120, which may be a video stream, an audio stream, a group chat, a whiteboard (e.g., a shared canvas), or another type of content.

Accordingly, the communication session module 118 may include video codecs, audio filtering software, face and voice recognition ability, speech-to-text processing, text-to-speech processing, drawing software, etc. The communication session module 118 may additionally include any other feature or functionality that is found in group collaboration, videoconference, online meeting, audio conference, a whiteboard, or group chat software.

In alternative configurations, the communication session module 118 may be stored on one of the computing devices 110. The communication session module 118 may also be stored in another network location or otherwise made available to the computing devices 110.

Although the network(s) 112 connect the computing devices 110 participating in the communication session, one or more of the computing devices 110 and the respective participants may be at the same location such as in the same conference room. Thus, some or all of the participants in the communication session may have the option of communicating with each other face-to-face. Videoconferencing or similar technology implemented by the communication session module 118 may share these in-person communications over the network(s) 112 with participants at other locations.

The server 116 also includes an agenda module 126. The agenda module 126 is configured to access and/or generate an agenda 128 for the communication session 122. The agenda 128 includes a sequence of agenda items 130, as well as metadata 132 associated with the agenda items 130 For example, the metadata 132 can include a time segment 134 assigned to each agenda item 130. The metadata 132 may further include a designation 136 of whether the time segment assigned to an agenda item 130 can be extended to accommodate additional discussion, or whether the time segment assigned to an agenda item 130 is restricted thereby preventing any additional discussion. The metadata 132 can also include behavior-related goals 138 for the agenda items 130 as a whole, or for an individual agenda item 130.

The agenda module 126 can be configured to retrieve the agenda 128 from a scheduling object (e.g., a calendar appointment) or another external source. Alternatively, the agenda module 126 can automatically create the agenda 128 based on a type of communication session (e.g., a team meeting that re-occurs on a weekly basis and that has a predetermined set of topics typically discussed in each meeting).

The agenda module 126 is configured to use a timer 140 to determine adaptations to the agenda 128. In one embodiment, the timer 140 can be used to manage the display of timing information associated with an agenda item 130. For example, the timer 140 can be used to determine an amount of remaining time to discuss an agenda item and to display the amount of remaining time (e.g., one minute remains of a ten minute segment assigned to an agenda item). In further embodiments, the timer 140 can be used to make adjustments to time segments assigned to the agenda items 130.

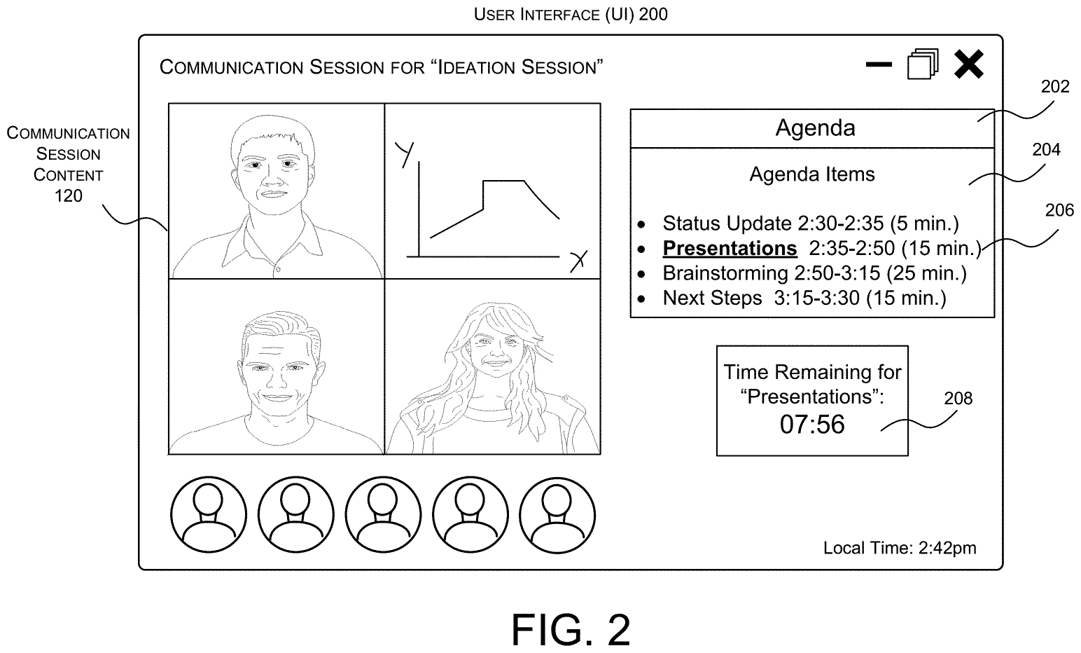

Accordingly, the agenda module 126 is configured to monitor the flow of discussion during a communication session 122 and to detect adaptations to the agenda 128. Examples of these adaptations are further described herein with respect to the illustrative user interfaces of FIGS. 2-12. If the flow of discussion strays from the original order of agenda items 130 in the agenda 128 and/or from the originally assigned time segments 134, then the agenda module 126 can adapt the agenda 128 and display information associated with the adapted agenda 142 in the user interface 124. An adaptation can include a time adjustment to accommodate an out-of-order discussion of topics, or to accommodate additional time wanted to discuss a topic.

In one embodiment, the agenda module 126 can determine that a topic currently being discussed during a time segment 134 assigned to a current agenda item 130 is associated with another agenda item 130 in the sequence of agenda items 130. To do this, the agenda module 126 can recognize words being spoken and use a trained model to map the recognized words to a linguistic context associated with a topic. In various examples, the model may use neural networks and/or natural language processing techniques to map the recognized words to a linguistic context, and determine when the linguistic context changes (e.g., the discussion switches from a first topic to a second topic). Consequently, the model is configured to map different words, spoken over time, to different linguistic contexts in order to determine that a topic currently being discussed during a time segment 130 assigned to an agenda item 130 is associated with another agenda item 130 in the sequence of agenda items 130.

In another embodiment, the agenda module 126 can determine that a predetermined amount of time remains for a time segment 130 assigned to a current agenda item 130 being discussed. At this point, the agenda module 126 can access the metadata 132 to determine whether the current agenda item has an extendable designation or a restricted designation 136, and the agenda module 126 can display a reminder to the participants indicating that the predetermined amount of time remains and that the current agenda item is either extendable or restricted.

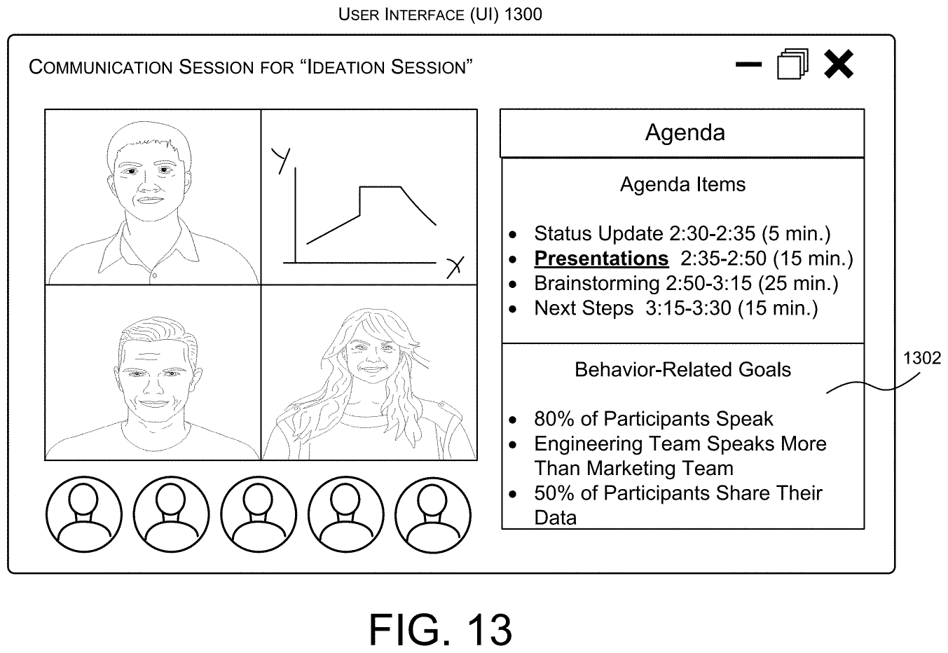

In further configurations, the agenda 128 can inform participants of behavior-related goals 138 associated with participation and inclusivity. Example of this are further described with respect to the user interfaces in FIGS. 13-15. The behavior-related goals 138 can be determined based on data aggregation from previous communication sessions with the same or similar participants. Accordingly, the communication session module 118 hosting a current communication session 122 and/or the aforementioned previous communication sessions can be configured to collect participation data 144. The participation data 144 can be derived via speech recognition and/or image analysis. Accordingly, in addition to recording and transmitting speech data to the communication session module 118, the computing devices 110 may be configured with image capture components that can obtain and transmit image data (e.g., photos and/or videos of the participants).

The communication session module 118 can identify a participants who speaks, track how many times a particular participant speaks, detect user actions (e.g., gestures, facial expressions, direction of gaze, etc.) from image data, and so forth. In one specific example, a behavior-related goal can indicate that bad behavior (e.g., user interruptions, negative facial expressions, etc.) from a previous communication session is to be removed from the current communication session. In another specific example, a behavior-related goal can encourage one or more specific participants to share ideas since the one or more specific participants were generally silent during the previous communication session. In yet another specific example, a behavior-related goal can encourage a first group of participants (e.g., sales people) to allow another group of participants (e.g., accounting people) to share ideas since the first group had the opportunity to share its ideas during a previous communication session and the second group did not have this opportunity.

To this end, the communication session module 118 can include a voice recognition component configured to receive the speech data from the computing devices 110 and to recognize a participant voice that speaks an utterance. Thus, the communication session module 118 can match a voice with a voice recognition profile to identify a user that spoke. A voice recognition profile can be built or trained for an individual user as the user speaks (e.g., during the meeting or other times before the meeting such as in previous meetings). Consequently, the communication session module 118 is configured to analyze a specific voice of a user and tune the recognition of the user's speech based on the analysis to increase voice recognition accuracy. This allows the communication session module 118 to determine, as part of the participation data 144, a number of participants who have spoken, the identities of those that spoke, a number of times an individual participant speaks, etc.

A behavior-related goal may be applicable to the all the agenda items 130, to a subset of the agenda items 130, or to a specific agenda item 130. As a communication session 122 progresses and an agenda item 130 is discussed, the communication session module 118 may be configured to collect the participation data 144. The agenda module 126 may then analyze the participation data 144 to determine that a behavior-related goal, as defined by an organizer or other participant, has not been satisfied. For instance, the agenda module 126 can determine that: a threshold number of people participating in the communication session 122 have not spoken, a threshold number of people participating in the communication session 122 have not shared a screen, a threshold number of people participating in the communication session 122 have not drawn an object on a whiteboard, a number of interruptions exceeds a minimum allowed number of interruptions, etc.

The agenda module 126 can then generate a reminder for display. The reminder may notify the participants that the behavior-related goal 138 has not been satisfied. In one embodiment, the reminder may only be displayed for a specific participant, such as the organizer, and thus, the organizer can take steps to ensure that efforts are made to improve participation and inclusivity with respect to the behavior-related goal 138.

In various examples, the agenda 128 can include an agenda item for a break (i.e., a “break agenda item”). The agenda module 126 can be configured to identify participants expected to attend the communication session 122 and determine a time segment to assign to the break agenda item while considering reasons the identified participants may need or want a break. For example, the time segment can be determined to accommodate a nursing mother who may need to pump. The time segment can be determined to accommodate religious activities (e.g., prayer time). The time segment can be determined to accommodate a bathroom visit for an individual with a disability. The time segment can be determined to accommodate consumption of medication for an individual with an illness. Since these are personal reasons the participants may want to keep private, the break agenda item does not disclose the reason for the break and/or the length of the break.

The user interface 124 may be sent or provided by the server 116. The server 116 may send bitmaps or otherwise provide the user interface 124 substantially complete to the computing devices 110. Alternatively, the server 116 may send instructions or commands (and content data) to software or hardware on the computing devices 110 that causes the computing devices 110 to present the user interface 124. The way in which the server 116 provides a user interface 124 may be different for different computing devices 110 based on the capability of the computing device 110, the network connection, user settings, and other factors.

FIG. 2 shows an illustrative user interface 200 for displaying information associated with an adaptable agenda during a communication session. This UI 200 may be an example of the user interface 124 in FIG. 1, and thus the user interface 200 includes the session content 120.

The UI 200 further includes the agenda 202 (e.g., agenda 128). The agenda 202 includes a sequence of agenda items 204 (e.g., the agenda items 130) to be discussed. More specifically, in this example, the agenda items 204 are entitled “Status Update”, “Presentations”, “Brainstorming”, and “Next Steps”. Each agenda item 204 may be associated with an assigned time segment, which may be represented by local time (e.g., 2:30-2:35 pm, 2:35-2:50 pm, 2:50-3:15 pm, 3:15-3:30 pm) or a total length of time (e.g., five minutes, fifteen minutes, twenty-five minutes, fifteen minutes).

The agenda 202 can be configured to visually distinguish a current agenda item 206 being discussed from other agenda items. As shown, the “Presentations” agenda item is the current agenda item 206, and thus, “Presentations” is bolded and underlined in this example to inform the participants that “Presentations” is the current agenda item being discussed.

Additionally, the UI 200 may display timing information associated with the agenda 202. The timing information may display an amount of time remaining to discuss a current agenda item. In FIG. 2, the amount of time remaining 208 to discuss “Presentations” is seven minutes and fifty-six seconds (i.e., “07:56”).

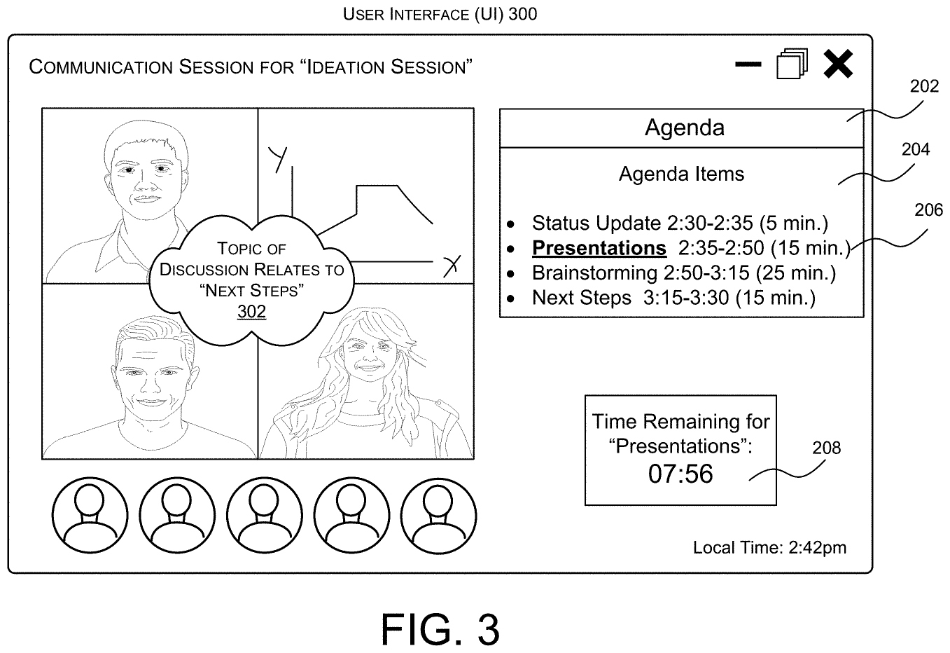

Aspects of FIG. 2 may be used as a basis for illustrating the adaptations further described herein with respect to FIGS. 3-12B.

FIG. 3 shows an illustrative UI 300 in which the agenda module 126 determines that a topic currently being discussed during a time segment assigned to a current agenda item is associated with another agenda item in the sequence of agenda items. As shown, at some point during the “Presentations” time segment (e.g., at 2:42 pm local time), the course of discussion changes from “Presentations” to “Next Steps” 302. Alternatively, the “Presentations” discussion may be determined to incorporate the “Next Steps” discussion 302 (e.g., the topics are discussed simultaneously).

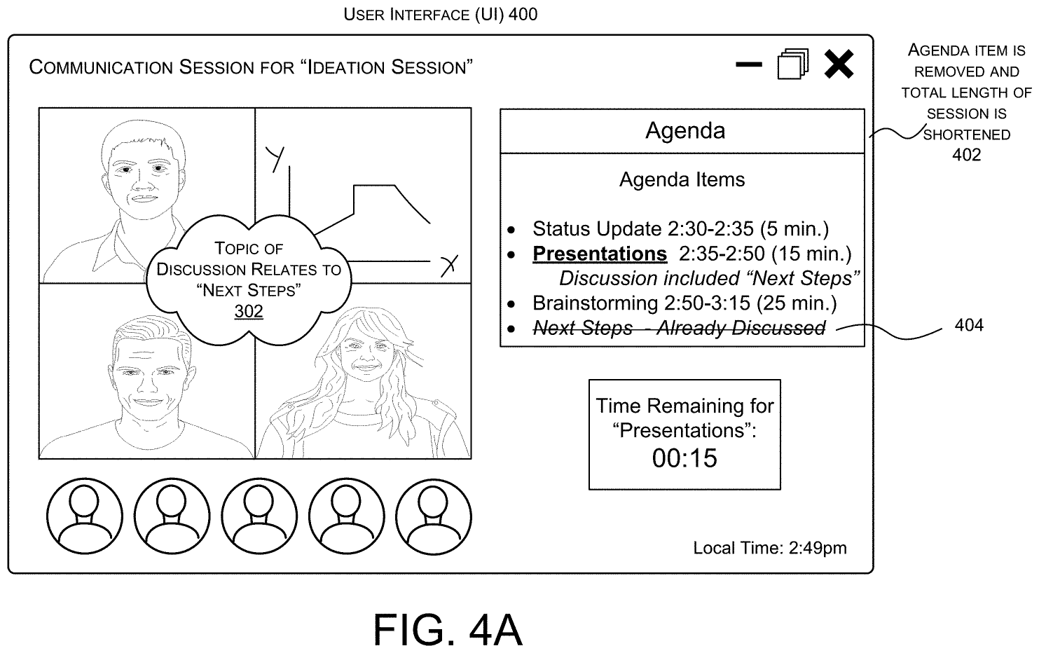

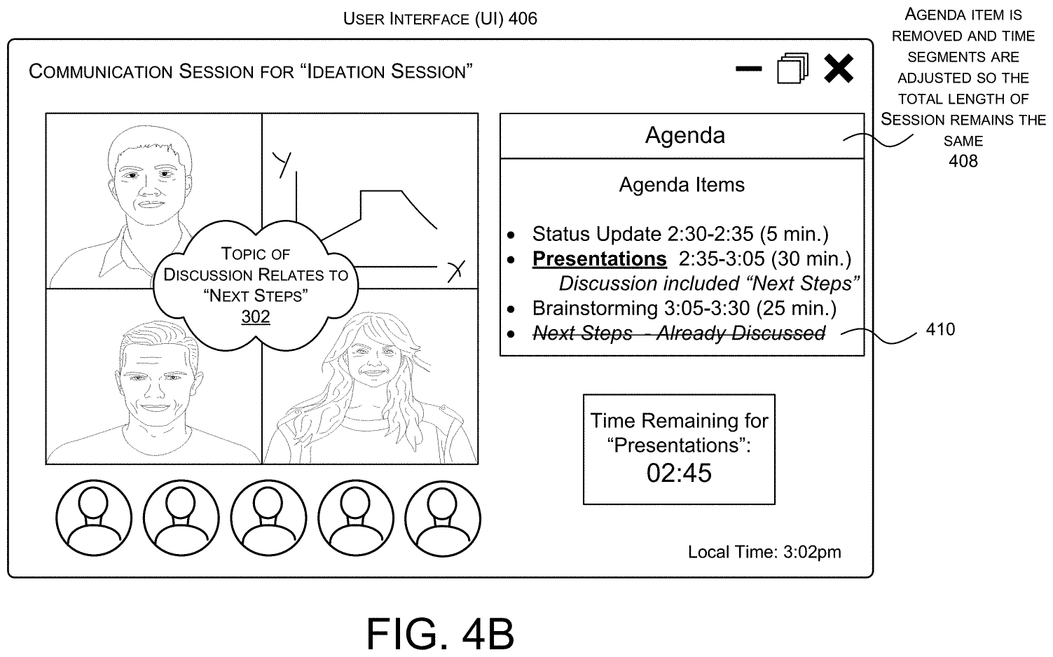

In association with the determination that “Next Steps” is discussed during a time segment assigned to “Presentations”, the agenda module 126 is configured to adapt the agenda 202. As illustrated in the example UI 400 of FIG. 4A, an agenda item can be removed when the discussion of two agenda items is sufficiently covered within a time segment assigned to a single agenda item. This UI 400 may be an example of the user interface 124 in FIG. 1. In this scenario, a total length of scheduled time for the communication session is shortened 402. More specifically, the agenda module 126 can indicate that the discussion of the “Next Steps” agenda item is grouped with the discussion of the “Presentations” agenda item. Moreover, the original “Next Steps” agenda item can be removed from the agenda 404. This type of adaptation changes the scheduled end time for the communication session (e.g., from 3:30 pm to 3:15 pm). This example UI 400 shows that fifteen seconds remain for the scheduled “Presentations” agenda item.

FIG. 4B shows an illustrative UI 406 in which an agenda item is removed and a time segment assigned to a current agenda item is extended to accommodate the discussion of two agenda items. This UI 406 may be an example of the user interface 124 in FIG. 1. In this scenario, a total length of the communication session remains the same 408, or close to the same time. More specifically, the agenda module 126 can indicate that the discussion of the “Next Steps” agenda item is grouped with “the discussion of the “Presentations” agenda item. Moreover, the original “Next Steps” agenda item can be removed from the agenda 410. This type of adaptation changes the assigned time for the “Presentations” agenda item from fifteen to thirty minutes and shifts the other time segments for the other agenda items so that the scheduled end time for the communication session remains the same (i.e., 3:30 pm local time). This example UI 406 shows that two minutes and forty-five seconds remain in the adjusted time segment for the “Presentations” agenda item.

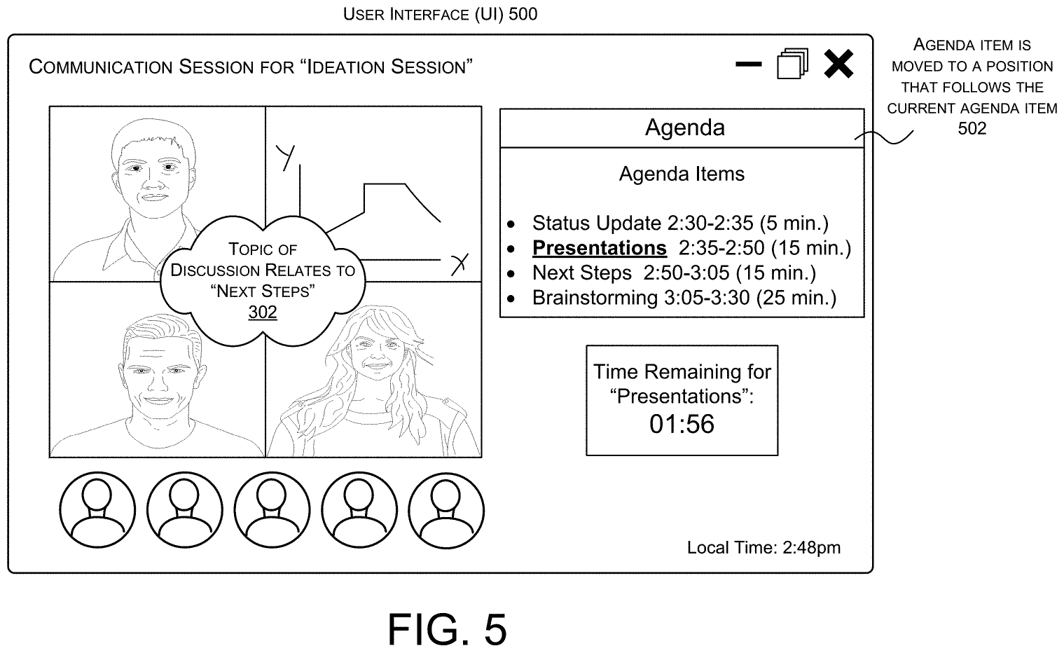

FIG. 5 shows an illustrative UI 500 in which an agenda item is moved to a position in the agenda that immediately follows the current agenda item 502. This UI 500 may be an example of the user interface 124 in FIG. 1. Since the discussion of “Next Steps” occurs in association with, or subsequent to, the “Presentations” agenda item currently being discussed, then the agenda module 126 can be configured to move the “Next Steps” agenda item to a position that immediately follows the “Presentations” agenda item. As shown in this example, the “Next Steps” agenda item is switched with the “Brainstorming” agenda item. Moreover, the agenda module 126 can shift the time segments accordingly. This provides the participants with more time to discuss “Presentations” and “Next Steps” together, or one directly after the other.

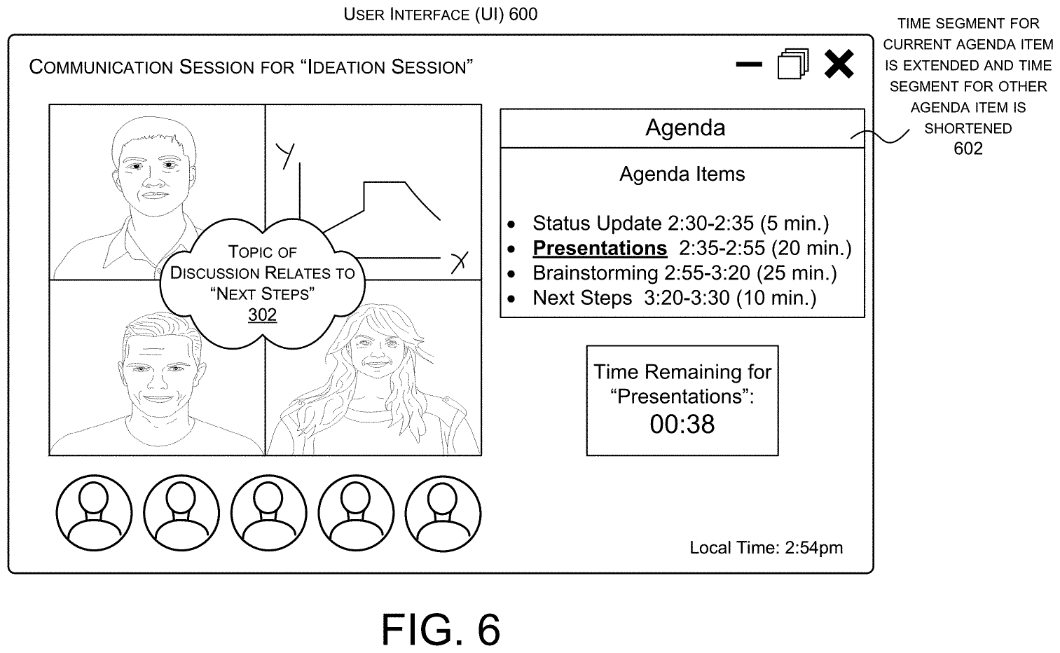

FIG. 6 shows an illustrative UI 600 in which a time segment assigned to the current agenda item is extended while a time segment assigned to another agenda item is shortened 602. This UI 600 may be an example of the user interface 124 in FIG. 1. As illustrated, the time segment for the “Presentations” agenda item currently being discussed is extended by five minutes, when compared to the original time segment in FIG. 2. This accommodates an initial discussion of “Next Steps”. Moreover, the original time segment for the “Next Steps” agenda item is shortened from fifteen minutes to ten minutes in order to ensure that the communication session is still scheduled to end on time.

In some embodiments, the agenda module 126 can use a timer 140 to determine an amount of time “Next Steps” was discussed out of order. This amount of time can be used to extend the original time segment for “Presentations” and to reduce the original time segment for “Next Steps”.

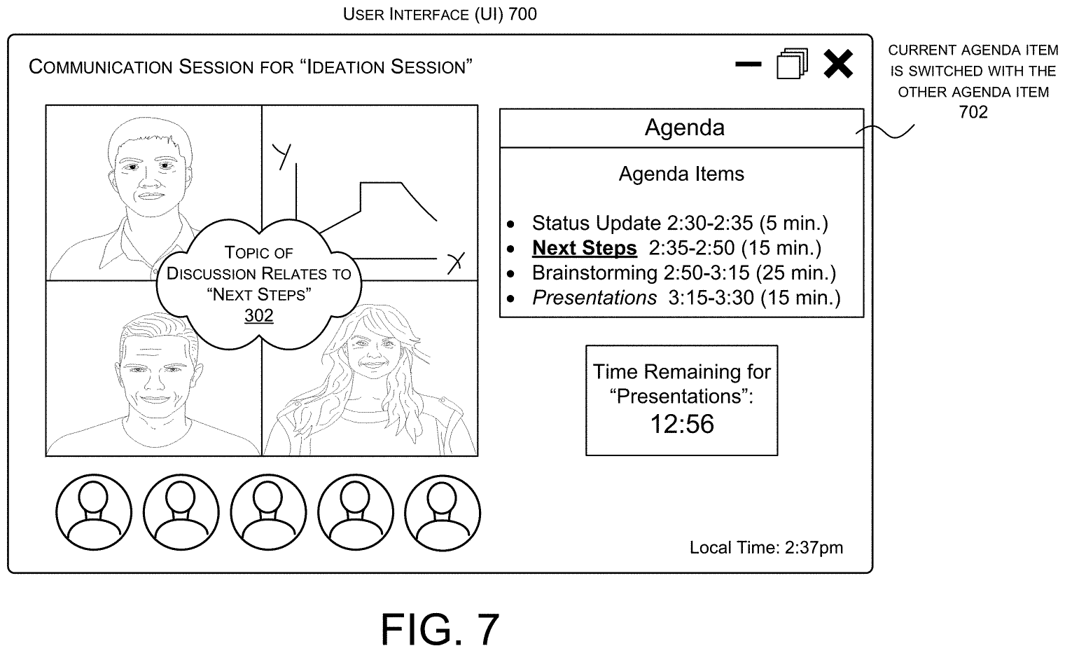

FIG. 7 shows an illustrative UI 700 in which agenda items can be switched. This UI 700 may be an example of the user interface 124 in FIG. 1. If the agenda module 126 determines that there was little to no discussion related to “Presentations” during the assigned time segment for “Presentations”, but rather, the discussion quickly shifted to “Next Steps”, then the agenda module 126 can be configured to switch a position of the current agenda item (e.g., “Presentations”) with a position of the other agenda item (e.g., “Next Steps”) in the sequence of agenda items 702.

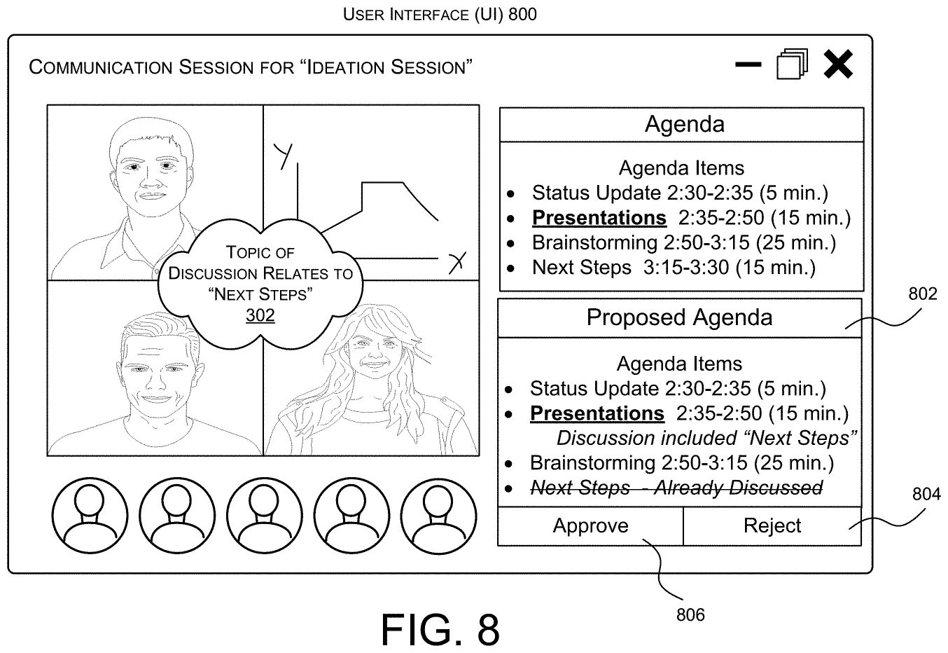

FIG. 8 shows an illustrative UI 800 in which a request to approve an adaptation to an agenda can be sent to an authorized person. This UI 800 may be an example of the user interface 124 in FIG. 1. As shown, the UI 800 can detect one of the aforementioned adaptations to the agenda and propose the adaptation 802 on a user interface of the authorized person. The adaptation in the example of FIG. 8 corresponds to the adaptation discussed with respect to FIG. 4A. Before implementing the adaptation and displaying the adaptation to the participants of the communication session, the agenda module 126 is configured to request that the authorized person, such as the organizer of the communication session, either reject 804 or approve 806 the proposed adaptation. With an approval, the agenda module 126 can implement the adaptation and display the adaptation to the participants of the communication session.

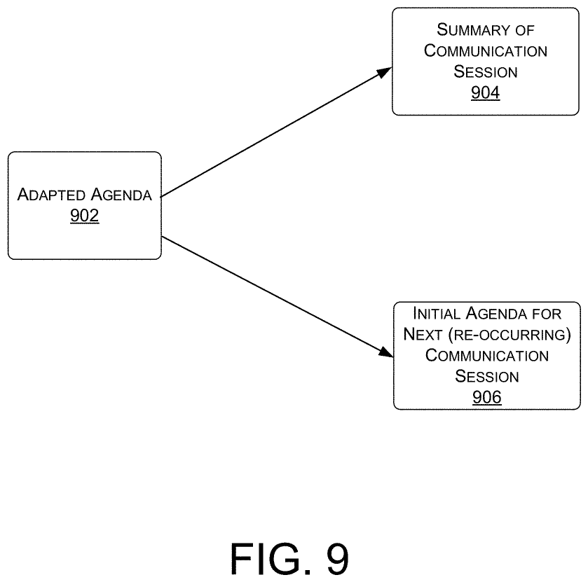

FIG. 9 illustrates an example of how an adapted agenda 902 can be used to generate a summary of the communication session 904, as well as an initial agenda for a next communication session 906. The summary 904 can be distributed to the participants of the communication session 122 in an email or another form of communication after the communication session 122 has ended. The summary 904 can show the actual order of agenda items discussed and/or the actual amounts of time spent discussing the agenda items. The summary 904 of the communication session 122 can further include: content that was shared with respect to an agenda item, objects that were drawn on a digital whiteboard with respect to an agenda item, actionable tasks that need to be performed with respect to an agenda item, contentious points of discussion with respect to an agenda item, identifications of participants that discussed an agenda item, and so forth.

The initial agenda 906 can be generated for a next communication session in a scenario where the participants are invited to a re-occurring communication session (e.g., a weekly team meeting, a weekly project meeting). The re-occurring communication session may include a standard set of topics to discuss, and thus, the techniques described herein are able to adapt an agenda over time so it better reflects the natural flow of discussion from one topic to the next, as well as the correct amounts of time to assign to the different topics.

In various examples, the agenda 128 can include an agenda item for a break (i.e., a “break agenda item”). The agenda module 126 can be configured to identify participants expected to attend the communication session 122 and determine a time segment to assign to the break agenda item while considering known personal factors for the identified participants. For example, the time segment can be determined to accommodate a nursing mother who may need to pump. The time segment can be determined to accommodate religious activities (e.g., prayer time). The time segment can be determined to accommodate a bathroom visit for an individual with a disability. The time segment can be determined to accommodate consumption of medication for an individual with an illness. Since these personal factors may be private, the break agenda item does not disclose the reason for the break and/or the length of the break, thereby protecting the privacy of the participants.

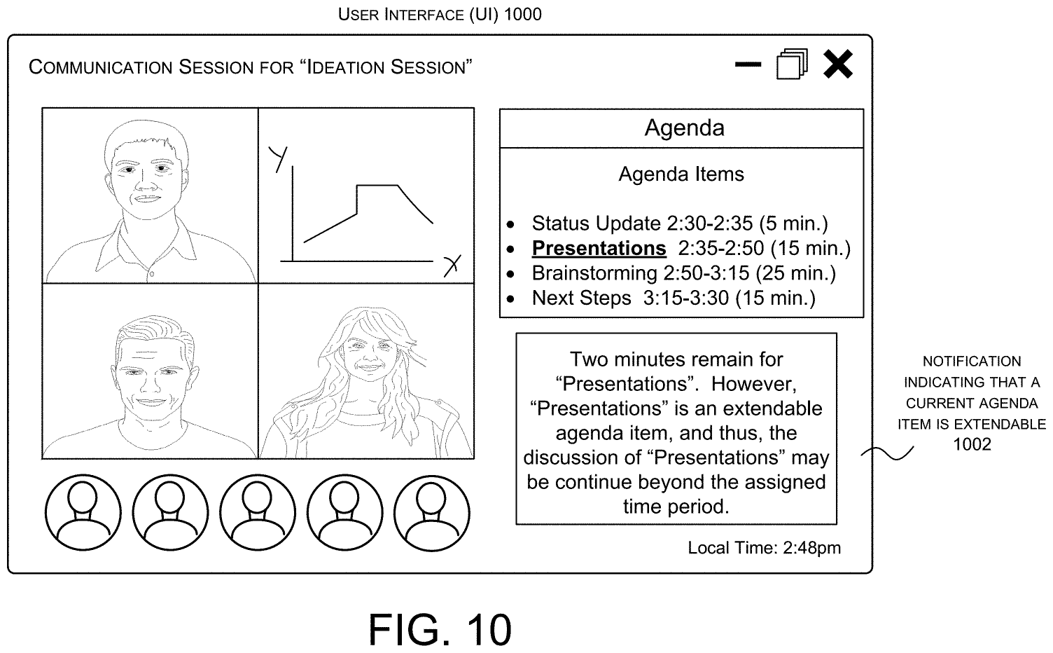

FIG. 10 shows an illustrative UI 1000 in which a notification indicating that a current agenda item is designated as an extendable agenda item can be displayed. This UI 1000 may be an example of the user interface 124 in FIG. 1. As described above, an agenda item can be associated with metadata 132 indicating whether an assigned amount of time to discuss the agenda item can be extended 136. The UI 1000 provides a visual notification 1002 when a predetermined amount of time (e.g., two minutes) remains in a time segment assigned to a current agenda item (e.g., “Presentations”). Furthermore, based on the designation in the metadata 132, the visual notification 1002 can indicate that the current agenda item is extendable.

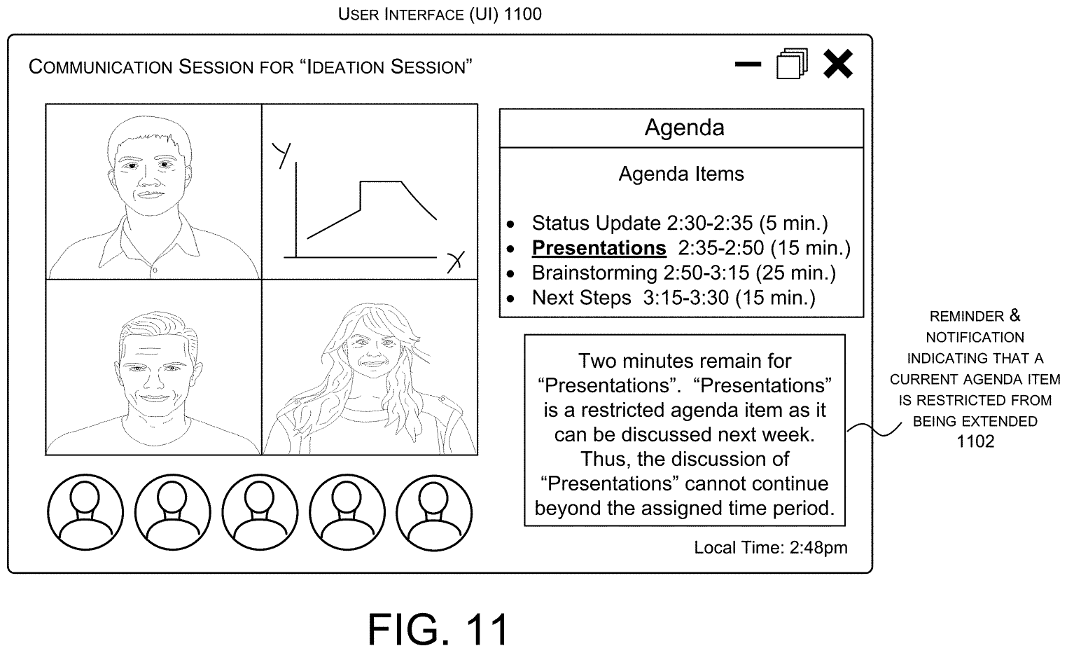

Similarly, FIG. 11 shows an illustrative UI 1100 in which a notification indicating that a current agenda item is designated as a restricted agenda item can be displayed. This UI 1100 may be an example of the user interface 124 in FIG. 1. The UI 1100 provides a visual notification 1102 when a predetermined amount of time (e.g., two minutes) remains in a time segment assigned to a current agenda item (e.g., “Presentations”). Furthermore, based on the designation in the metadata 132, the visual notification 1002 can indicate that the current agenda item is restricted (e.g., cannot or should not be extended).

The notifications 1002 and 1102 can be used to let participants know that the conversation surrounding a topic should wrap up because it is not to be extended or that the conversation surrounding the topic can be extended if needed. An organizer, or another participant to the communication session, can designate an agenda item as extendable or restricted based on a level of importance of a topic. For instance, time extensions may more likely be allowed to discuss more important topics while the organizer may wish to ensure that discussions of less important topics are not extended beyond an assigned amount of time. Additionally or alternatively, an organizer can designate an agenda item as extendable or restricted based on whether a topic can be discussed in a next communication session (e.g., the next weekly team meeting). For example, a topic may be part of a standard set of topics discussed in a team meeting each week. In another example, a time extension may more likely be allowed to discuss a topic associated with an event that is scheduled to occur within a predetermined time period (e.g., the next day, the coming week, etc.). However, the time extension may not be allowed to discuss a topic associated with an event that is scheduled outside the predetermined time period (e.g., a month out) because the team will be able to discuss the topic in greater detail during the next weekly team meeting.

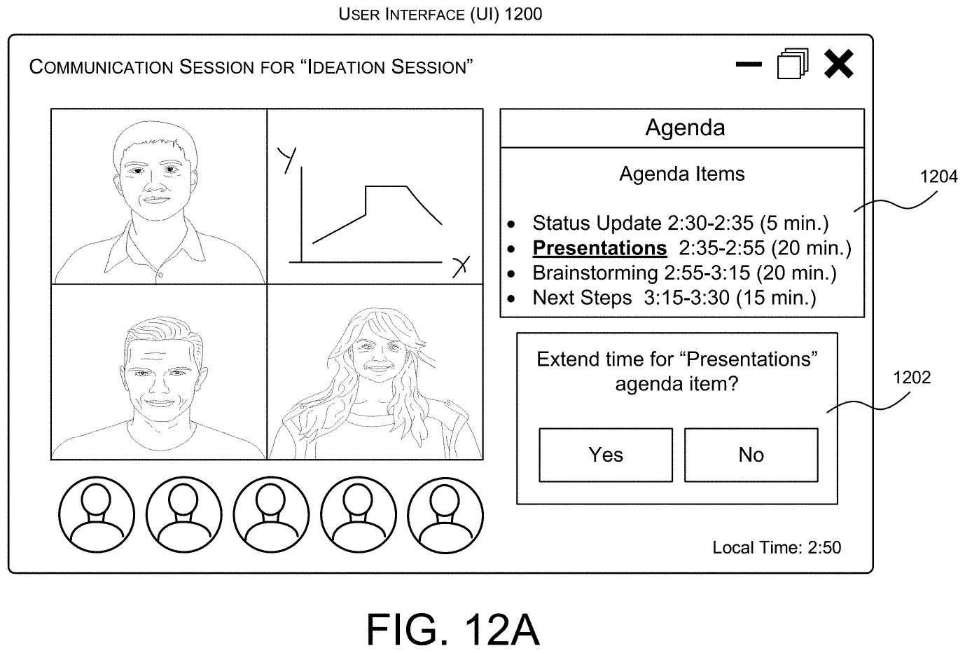

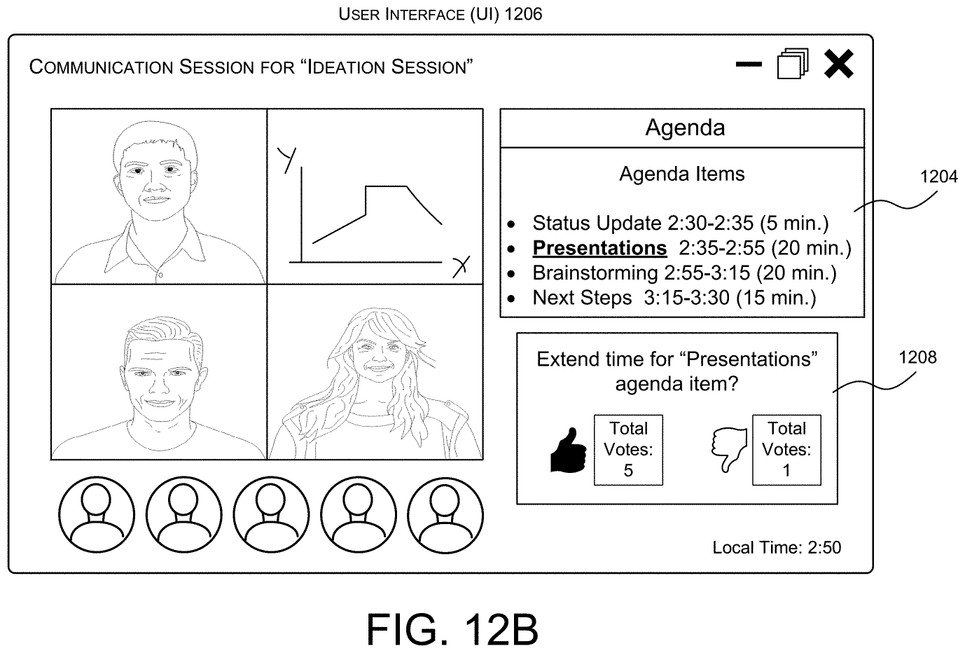

FIG. 12A shows an illustrative UI 1200 in which a request for approval 1202 to extend a time period for a current agenda item is displayed. An authorized person such as the organizer can authorize the extension by selecting “Yes”. Moreover, if the time for the current agenda item is extended, the agenda module 126 can adapt the agenda 1204 to reflect the extension (e.g., time segments can be adjusted).

FIG. 12B shows an illustrative user interface 1206 in which a group request for approval to extend a time period for a current agenda item is displayed. Similar to FIG. 12A, the user interface 1206 includes a request 1208 for approval to extend a time period for the “Presentations” agenda item. However, in this example, the request 1208 can be sent to a group of participants and each participant in the group can provide approval (e.g., select a thumbs-up icon) to extend the current agenda item or disapprove of the extension (e.g., select a thumbs-down icon). Moreover, in some embodiments, the request 1208 can display a number of votes for approval and/or disapproval. In this way, the participants are informed of the group sentiment with regard to whether a current agenda item should be extended.

FIG. 13 shows an illustrative UI 1300 in which behavior-related goals 1302 can be displayed. A behavior-related goal may be applicable to all the agenda items in the agenda, to a subset of agenda items in the agenda, or to a specific agenda item in the agenda. As shown, the behavior related goals 1302 include a goal that a predetermined percentage (e.g., eighty percent) of participants speak, a goal that the engineering team speaks more than the marketing team (e.g., with respect to time), and/or a goal that a predetermined percentage of participants (e.g., fifty percent) share their data.

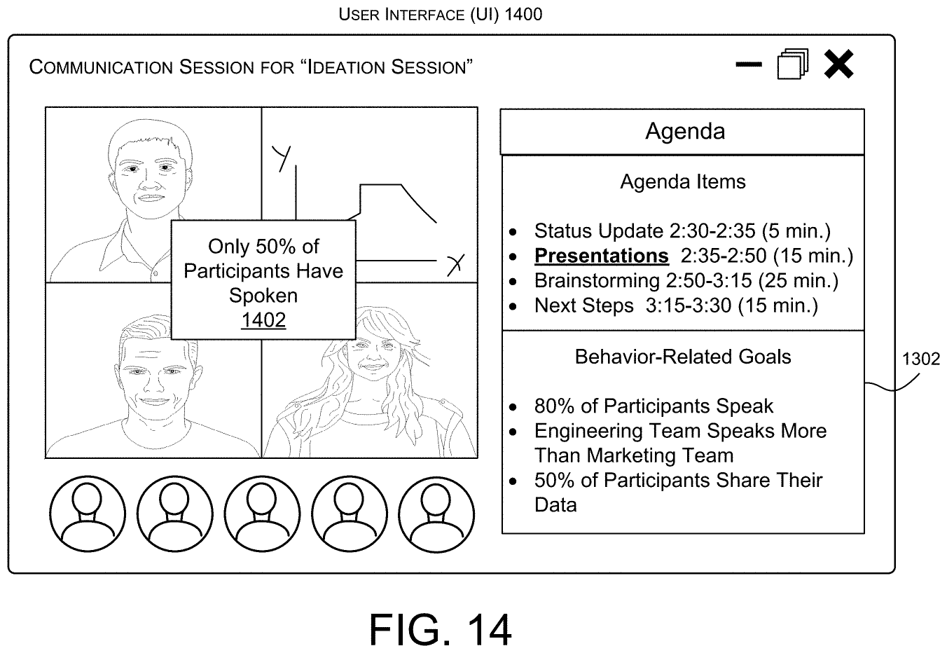

As a communication session progresses and an agenda item is discussed, the communication session module 118 may be configured to collect data associated with participation and analyze the data to determine that one of the behavior-related goals 1302 has not been satisfied. For instance, the communication session module 118 can determine that: eighty percent of the participants have not spoken, that the marketing team has spoken more than the engineering team, and/or that less than fifty percent of the participants have not shared their data, etc. Accordingly, as shown in the illustrative UI 1400 of FIG. 14, a notification 1402 can be displayed to select participants (e.g., the organizer) or all the participants, the notification 1402 indicating that one of the behavior-related goals has not been satisfied.

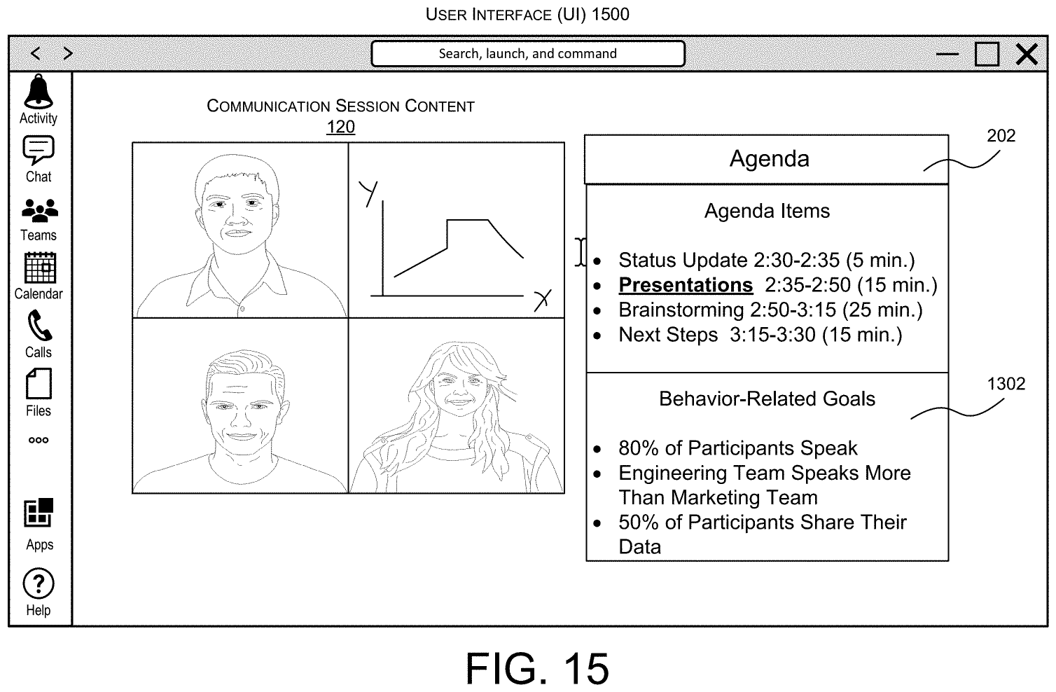

FIG. 15 shows an illustrative UI 1500 for displaying aspects of an adapted agenda in an example collaboration application. A collaboration application is a software application that may hold a variety of content for multiple users to interact with simultaneously and/or sequentially. The collaboration application may include functionality such as a chat function, live video streams, live audio streams, and file sharing. Examples of collaboration applications include MICROSOFT TEAMS, SLACK, GOOGLE HANGOUTS, and FACEBOOK WORKPLACE. The collaboration application may be any type of application and is not limited to only applications with specific types of functionality (e.g., video streaming, audio streaming, etc.).

The UI 1500 includes a UI element that presents the communication session content 120. For example, the communication session content 120 may be presented in a video window. While simultaneously displaying the communication session content 120, the UI 1500 may also present an agenda 202, with implemented adaptations. Moreover, the UI 1500 may also present behavior-related goals 1302.

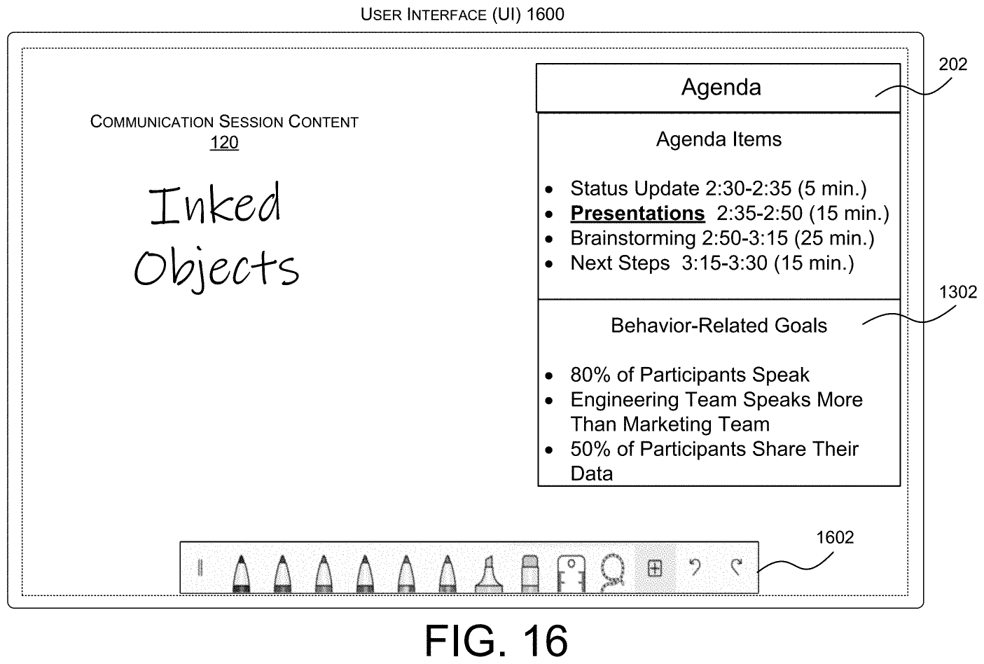

FIG. 16 is an illustrative UI 1600 for displaying aspects of an adapted agenda in an example inking/drawing application. The UI 1600 may be any type of touchscreen UI such as resistive, surface capacitive, projected capacitive, SAW (Surface Acoustic Wave), optical imaging, acoustic pulse recognition, infrared, or the like. The UI 1600 may be the touchscreen of a collaborative computing device such as a digital whiteboard. The UI 1600 may include the communication session content 120 displayed in white space on a canvas. While simultaneously displaying the communication session content 120, the UI 1600 may also present an agenda 202, with implemented adaptations. Moreover, the UI 1600 may also present behavior-related goals 1302. The UI 1600 can further include a toolbar 1602 that provides multiple tools for interacting with the touchscreen such as drawing tools that correspond to pencils, pens, highlighters, erasers, etc.

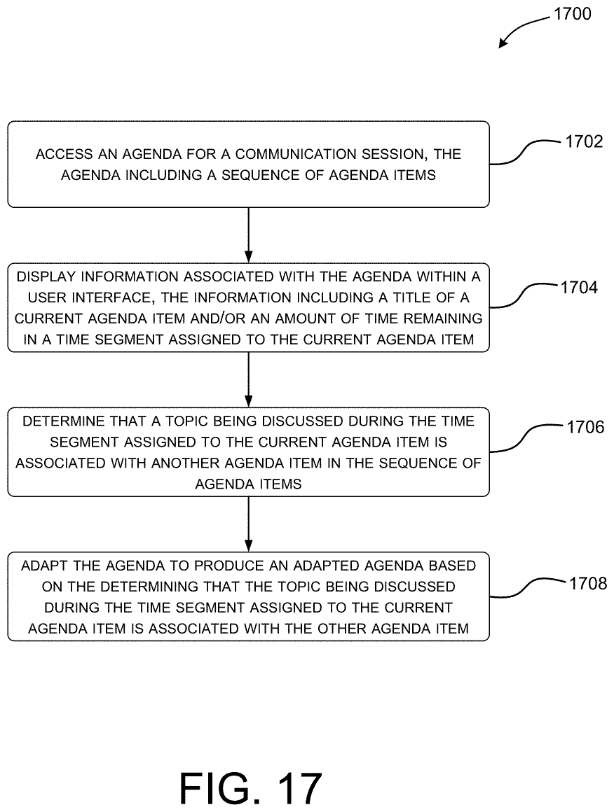

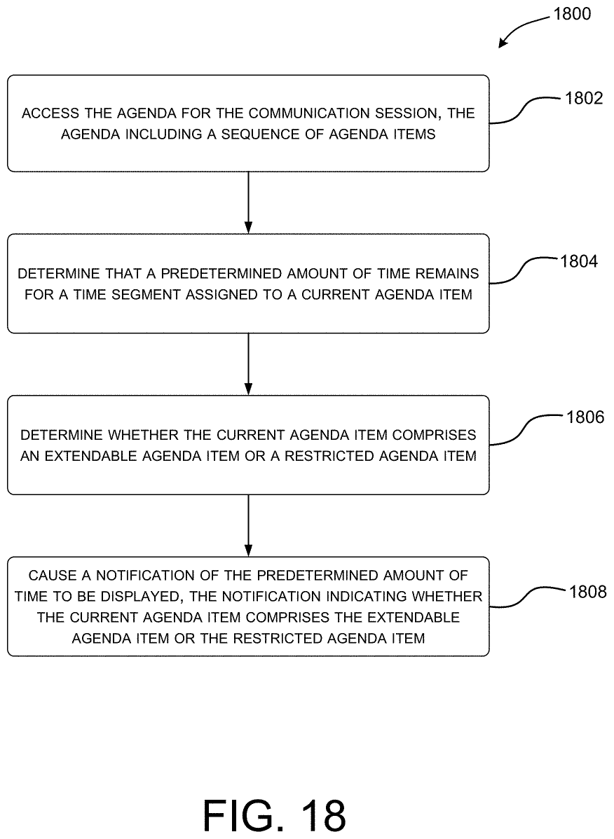

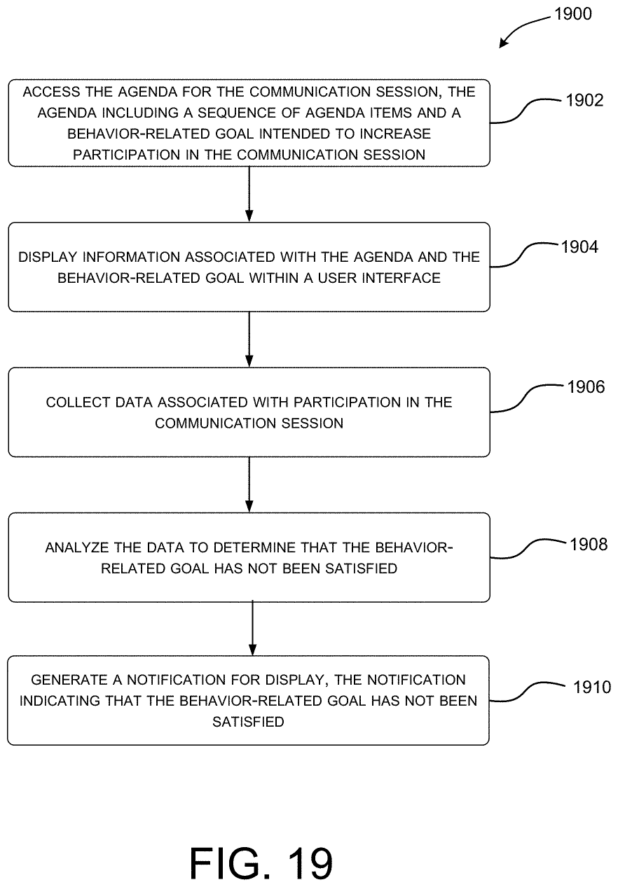

FIG. 17 is a flow diagram illustrating a routine 1700 describing aspects of the present disclosure. FIG. 18 is a flow diagram illustrating a routine 1800 for describing further aspects of the present disclosure. FIG. 19 is a flow diagram illustrating a routine 1900 for describing further aspects of the present disclosure. In various examples, operations of the routines 1700, 1800, 1900 can be performed by the server 116 and/or a participant computing device 110. The logical operations described herein with regards to any one of FIGS. 17-19 can be implemented (1) as a sequence of computer implemented acts or program modules running on a computing device and/or (2) as interconnected machine logic circuits or circuit modules within a computing device.

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-readable media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including processing units in single-processor or multiprocessor systems, minicomputers, mainframe computers, personal computers, hand-held computing devices, microprocessor-based, programmable consumer electronics, combinations thereof, and the like.

For example, the operations of the routines 1700, 1800, 1900 can be implemented by dynamically linked libraries (“DLLs”), statically linked libraries, functionality produced by an application programming interface (“API”), a compiled program, an interpreted program, a script, a network service or site, or any other executable set of instructions. Data can be stored in a data structure in one or more memory components. Data can be retrieved from the data structure by addressing links or references to the data structure.

Although the following illustration may refer to components of the figures, it can be appreciated that the operations of the routines 1700, 1800, 1900 may be also implemented in many other ways. For example, the routines 1700, 1800, 1900 may be implemented, at least in part, by a another remote computer, processor, or circuit. In addition, one or more of the operations of the routines 1700, 1800, 1900 may alternatively or additionally be implemented, at least in part, by a chipset working alone or in conjunction with other software modules. In the examples described below, one or more modules of a computing system can receive and/or process the data disclosed herein. Any service, circuit or application suitable for providing the techniques disclosed herein can be used in operations described herein.

With reference to FIG. 17, the routine 1700 begins at operation 1702 where an agenda for a communication session is accessed. At operation 1704, information associated with the agenda is displayed within a user interface. The information can include a title of a current agenda item and/or an amount of time remaining in a time segment assigned to the current agenda item.

At operation 1706, it is determined that a topic being discussed during the time segment assigned to the current agenda item is associated with another agenda item in the sequence of agenda items. And at operation 1708, the agenda is adapted to produce an adapted agenda based on the determining that the topic being discussed during the time segment assigned to the current agenda item is associated with the other agenda item. Example adapted agendas are provided in FIGS. 4A-7.

With reference to FIG. 18, the routine 1800 begins at operation 1802 where an agenda for a communication session is accessed. At operation 1804, it is determined that a predetermined amount of time remains for a time segment assigned to a current agenda item.

At operation 1806, it is determined whether the current agenda item comprises an extendable agenda item or a restricted agenda item. And at operation 1808, a notification of the predetermined amount of time is caused to be displayed. The notification indicates whether the current agenda item comprises the extendable agenda item or the restricted agenda item.

With reference to FIG. 19, the routine 1900 begins at operation 1902 where an agenda for a communication session is accessed. The agenda can include a sequence of agenda items and a behavior-related goal intended to increase participation in the communication session. At operation 1904, information associated with the agenda and the behavior-related goal is displayed within a user interface (124) that displays content of the communication session.

At operation 1906, data associated with participation in the communication session is collected. At operation 1908, the data is analyzed to determine that the behavior-related goal has not been satisfied. And at operation 1910, a notification is generated for display. The notification can indicate that the behavior-related goal has not been satisfied.

The communication session may be an in-person meeting between participants at a shared location. For example, there may be one or more conference rooms of people participating in a conventional meeting or conference. Each of the multiple conference rooms may be connected to the other by video conferencing or similar communication technology. Participants who are at the same location as others do not need a computing device to join the conference. However, due to the prevalence of laptop computers, tablets, and smartphones, participants who attend a meeting in person will likely have access to their own computing device during the communication session.

Many face-to-face meetings now include participants joining remotely via web conferencing or similar technologies. These remote participants will use a computing device to connect to the communication session. A remote participant may be the only meeting participant at his or her location or there may be a small group of participants joining from a single computing device. Even if this small group of participants uses a shared device to connect to the main content of the communication session, each of the participants will likely have access to an individual computing device. Thus, most conference participants, both local and remote, will have access to an individual computing device in order to provide anonymous comments in real-time during the communication session. Additionally, due to the prevalence of laptop computers, tablets, and smart phones, participants who attend communication sessions in person may also be accessing their own computing devices during the meeting to view graphical information related to the meeting (e.g., drawings on a digital whiteboard).

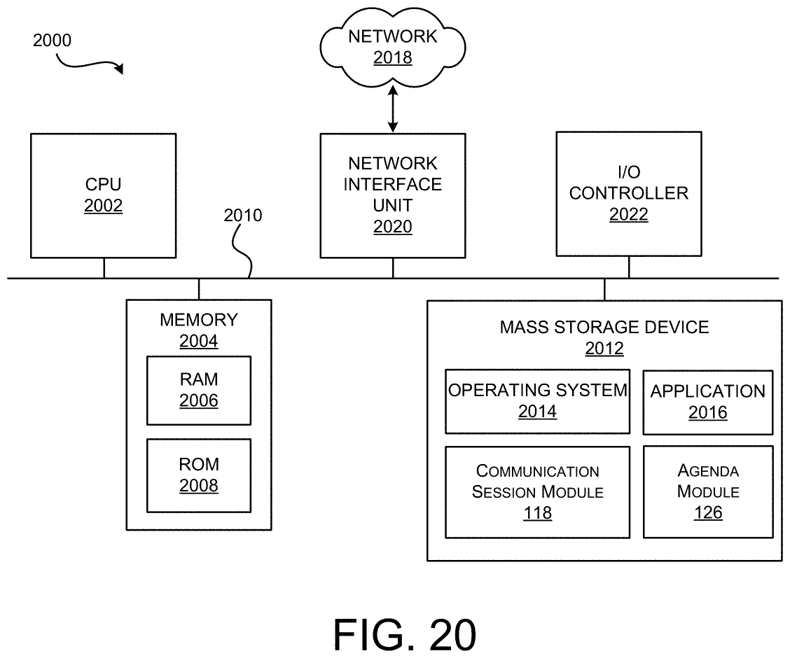

FIG. 20 shows additional details of an example computer architecture 2000 for a computer, such as the computing devices 110 and the server 116 shown in FIG. 1, capable of executing the program components described herein. Thus, the computer architecture 2000 illustrated in FIG. 20 illustrates an architecture for a server computer, a mobile phone, a personal digital assistant (PDA), a smartphone, a desktop computer, a collaborative computing device, a netbook computer, a tablet computer, and/or a laptop computer. The computer architecture 2000 may be utilized to execute any aspects of the software components presented herein.

The computer architecture 2000 includes a central processing unit 2002 (“CPU”), a system memory 2004, including a random access memory 2006 (“RAM”) and a read-only memory (“ROM”) 2008, and a system bus 2010 that couples the memory 2004 to the CPU 2002. A basic input/output system containing the basic routines that help to transfer information between elements within the computer architecture 2000, such as during startup, is stored in the ROM 2008. The computer architecture 2000 further includes a mass storage device 2012 for storing an operating system 2014, an application 2016, a communication session module 118, an agenda module 126, and other data, applications, or programs described herein.

The mass storage device 2012 is connected to the CPU 2002 through a mass storage controller (not shown) connected to the bus 2010. The mass storage device 2012 and its associated computer-readable media provide non-volatile storage for the computer architecture 2000. Although the description of computer-readable media contained herein refers to a mass storage device, such as a solid-state drive, a hard disk or a CD-ROM drive, it should be appreciated by those skilled in the art that computer-readable media can be any available computer-readable storage media or communication media that can be accessed by the computer architecture 2000.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer-readable storage media may include volatile and non-volatile, removable and non-removable media implemented in any method or technology for storage of information such as computer-readable instructions, data structures, program modules or other data. For example, computer-readable storage media includes, but is not limited to, RAM, ROM, EPROM, EEPROM, flash memory or other solid-state memory technology, CD-ROM, digital versatile disks (“DVD”), HD-DVD, BLU-RAY, 4K Ultra HD BLU-RAY, or other optical storage, magnetic cassettes, magnetic tape, magnetic disk storage or other magnetic storage devices, or any other medium which can be used to store the desired information, and which can be accessed by the computer architecture 2000. For purposes of the claims, the phrase “computer storage medium,” “computer-readable storage medium” and variations thereof, does not include waves, signals, and/or other transitory and/or intangible communication media, per se.

According to various configurations, the computer architecture 2000 may operate in a networked environment using logical connections to remote computers through the network 2018. The computer architecture 2000 may connect to the network 2018 through a network interface unit 2020 connected to the bus 2010. The computer architecture 2000 also may include an input/output controller 2022 for receiving and processing input from a number of other devices, including a keyboard, mouse, touchscreen, electronic stylus, or pen. Similarly, the input/output controller 2022 may provide output to a display screen, a printer, or another type of output device.

The software components described herein may, when loaded into the CPU 2002 and executed, transform the CPU 2002 and the overall computer architecture 2000 from a general-purpose computing system into a special-purpose computing system customized to facilitate the functionality presented herein. The CPU 2002 may be constructed from any number of transistors or other discrete circuit elements, which may individually or collectively assume any number of states. More specifically, the CPU 2002 may operate as a finite-state machine, in response to executable instructions contained within the software modules disclosed herein. These computer-executable instructions may transform the CPU 2002 by specifying how the CPU 2002 transitions between states, thereby transforming the transistors or other discrete hardware elements constituting the CPU 2002.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 2000 in order to store and execute the software components presented herein. It also should be appreciated that the computer architecture 2000 may include other types of computing devices, including hand-held computers, embedded computer systems, personal digital assistants, and other types of computing devices known to those skilled in the art. It is also contemplated that the computer architecture 2000 may not include all of the components shown in FIG. 20, may include other components that are not explicitly shown in FIG. 20, or may utilize an architecture completely different than that shown in FIG. 20.

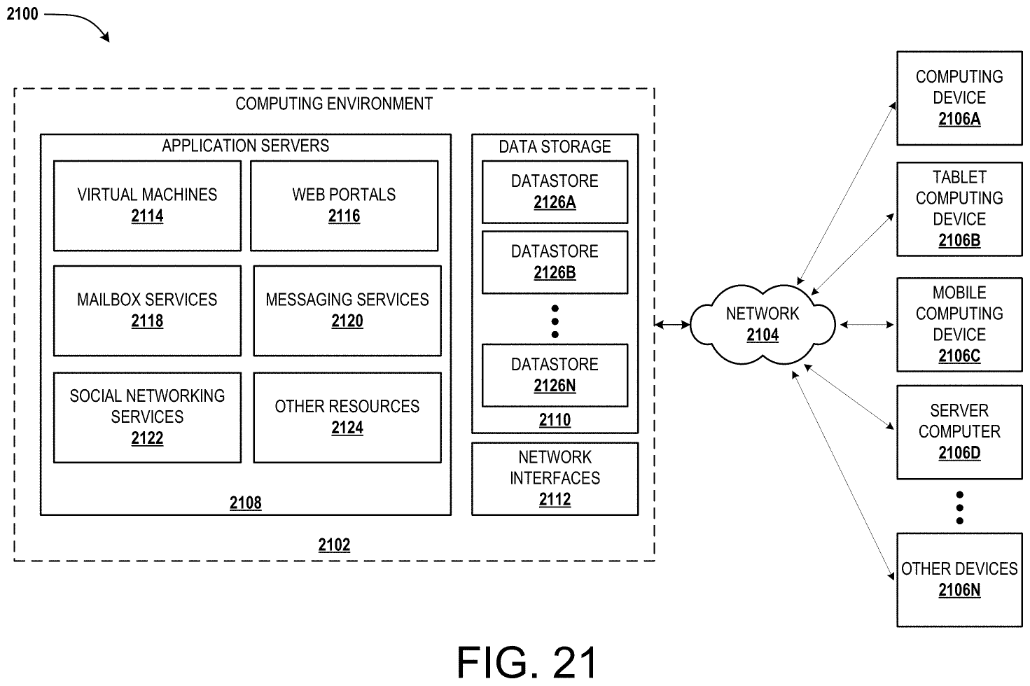

FIG. 21 depicts an illustrative distributed computing environment 2100 capable of executing the software components described herein. Thus, the distributed computing environment 2100 illustrated in FIG. 21 can be utilized to execute any aspects of the software components presented herein.

According to various implementations, the distributed computing environment 2100 includes a computing environment 2102 operating on, in communication with, or as part of the network 2104. One or more client devices 2106A-2106N (hereinafter referred to collectively and/or generically as “clients 2106” and also referred to herein as computing devices 2106) can communicate with the computing environment 2102 via the network 2104.

In one illustrated configuration, the clients 2106 include a computing device 2106A such as a laptop computer, a desktop computer, a collaborative computing device, or other computing device; a slate or tablet computing device (“tablet computing device”) 2106B; a mobile computing device 2106C such as a mobile telephone, a smartphone, or other mobile computing device; a server computer 2106D; and/or other devices 2106N. It should be understood that any number of clients 2106 can communicate with the computing environment 2102.

In the illustrated configuration, the computing environment 2102 includes application servers 2108, data storage 2110, and one or more network interfaces 2112. According to various implementations, the functionality of the application servers 2108 can be provided by one or more server computers that are executing as part of, or in communication with, the network 2104. The application servers 2108 can host various services, virtual machines, portals, and/or other resources. In the illustrated configuration, the application servers 2108 host one or more virtual machines 2114 for hosting applications or other functionality. According to various implementations, the virtual machines 2114 host one or more applications and/or software modules for implementing aspects of the functionality disclosed herein. It should be understood that this configuration is illustrative and should not be construed as being limiting in any way. The application servers 2108 can also host or provide access to one or more portals, link pages, Web sites, and/or other information (“web portals”) 2116.

According to various implementations, the application servers 2108 also include one or more mailbox services 2118 and one or more messaging services 2120. The mailbox services 2118 can include electronic mail (“email”) services. The mailbox services 2118 also can include various personal information management (“PIM”) and presence services including, but not limited to, calendar services, contact management services, collaboration services, and/or other services. The messaging services 2120 can include, but are not limited to, video conferencing services, audio conferencing services, instant messaging services, chat services, forum services, and/or other communication services.

The application servers 2108 also may include one or more social networking services 2122. The social networking services 2122 can include various social networking services including, but not limited to, services for sharing or posting status updates, instant messages, links, photos, videos, and/or other information; services for commenting or displaying interest in articles, products, blogs, or other resources; and/or other services.

As shown in FIG. 21, the application servers 2108 also can host other services, applications, portals, and/or other resources (“other resources”) 2124. The other resources 2124 can include, but are not limited to, workspace collaboration, document sharing, rendering or any other functionality. It thus can be appreciated that the computing environment 2102 can provide integration of the concepts and technologies disclosed herein with various mailbox, messaging, social networking, and/or other services or resources.

As mentioned above, the computing environment 2102 can include the data storage 2110. According to various implementations, the functionality of the data storage 2110 is provided by one or more databases operating on, or in communication with, the network 2104. The functionality of the data storage 2110 also can be provided by one or more server computers configured to host data for the computing environment 2102. The data storage 2110 can include, host, or provide one or more real or virtual datastores 2126A-2126N (hereinafter referred to collectively and/or generically as “datastores 2126”). The datastores 2126 are configured to host data used or created by the application servers 2108 and/or other data. Although not illustrated in FIG. 21, the datastores 2126 also can host or store web page documents, word documents, presentation documents, data structures, algorithms for execution by a recommendation engine, and/or other data utilized by any application program or another module. Aspects of the datastores 2126 may be associated with a service for storing data units such as files.

The computing environment 2102 can communicate with, or be accessed by, the network interfaces 2112. The network interfaces 2112 can include various types of network hardware and software for supporting communications between two or more computing devices including, but not limited to, the computing devices and the servers. It should be appreciated that the network interfaces 2112 also may be utilized to connect to other types of networks and/or computer systems.

It should be understood that the distributed computing environment 2100 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 2100 provides the software functionality described herein as a service to the computing devices.

It should also be understood that the computing devices can include real or virtual machines including, but not limited to, server computers, web servers, personal computers, mobile computing devices, smartphones, and/or other devices. As such, various configurations of the concepts and technologies disclosed herein enable any device configured to access the distributed computing environment 2100 to utilize the functionality described herein for providing the techniques disclosed herein, among other aspects. In one specific example, as summarized above, techniques described herein may be implemented, at least in part, by a web browser application, which works in conjunction with the application servers 2108 of FIG. 21.

The disclosure presented herein also encompasses the subject matter set forth in the following clauses.

Example Clause A, a system for adapting an agenda during a communication session, the system comprising: one or more processing units; and computer-readable media storing instructions that, when executed by the one or more processing units, cause the system to: access the agenda for the communication session, the agenda including a sequence of agenda items; display information associated with the agenda within a user interface that displays content of the communication session, wherein the information includes at least one of a title of a current agenda item in the sequence of agenda items and an amount of time remaining in a time segment assigned to the current agenda item; determine that a topic being discussed during the time segment assigned to the current agenda item is associated with another agenda item in the sequence of agenda items; and adapt the agenda to produce an adapted agenda based on the determining that the topic being discussed during the time segment assigned to the current agenda item is associated with the other agenda item.

Example Clause B, the system of Example Clause A, wherein the adapting the agenda to produce the adapted agenda comprises removing the other agenda item from the agenda.

Example Clause C, the system of Example Clause A, wherein the adapting the agenda to produce the adapted agenda comprises moving the other agenda item to a position in the agenda that immediately follows the current agenda item.

Example Clause D, the system of Example Clause A, wherein the adapting the agenda to produce the adapted agenda comprises: extending the time segment assigned to the current agenda item; and shortening a time segment assigned to the other agenda item.

Example Clause E, the system of Example Clause A, wherein the adapting the agenda to produce the adapted agenda comprises switching a position of the current agenda item with a position of the other agenda item in the sequence of agenda items.

Example Clause F, the system of any one of Example Clauses A through E, wherein the instructions further cause the system to: request that an authorized person approve the adapted agenda; and receive, based on input from the authorized person, approval of the adapted agenda, wherein the adapting the agenda to produce the adapted agenda is implemented based at least in part on the received approval.

Example Clause G, the system of any one of Example Clauses A through F, wherein the instructions further cause the system to use the adapted agenda to automatically generate an initial agenda for a next communication session, the communication session and the next communication session being part of a re-occurring communication session.

Example Clause H, the system of any one of Example Clauses A through G, wherein the instructions further cause the system to generate a summary of the communication session based on the adapted agenda.

Example Clause I, the system of any one of Example Clauses A through H, wherein: the agenda includes a break agenda item; a time segment assigned to the break agenda item is determined based at least in part on a reason for a break; and the break agenda item does not disclose the reason for the break thereby protecting privacy of one or more participants.

Example Clause J, a system for adapting an agenda during a communication session, the system comprising: one or more processing units; and computer-readable media storing instructions that, when executed by the one or more processing units, cause the system to: access the agenda for the communication session, the agenda including a sequence of agenda items; determine that a predetermined amount of time remains for a time segment assigned to a current agenda item of the sequence of agenda items; determine whether the current agenda item comprises an extendable agenda item or a restricted agenda item; and cause a notification of the predetermined amount of time to be displayed, the notification indicating whether the current agenda item comprises the extendable agenda item or the restricted agenda item.

Example Clause K, the system of Example Clause J, wherein the current agenda item is extendable and the instructions further cause the system to: determine that an end of the time segment assigned to the current agenda item has been reached; allow additional time for discussion of the current agenda item; and adapt the agenda to account for the additional time.

Example Clause L, the system of Example Clause K, wherein the adapting the agenda to account for the additional time comprises selecting another agenda item to shorten to ensure the communication session ends at a scheduled time, the other agenda item being associated with metadata indicating an ability to shorten the other agenda item.

Example Clause M, the system of any one of Example Clauses J through L, wherein determining whether the current agenda item comprises the extendable agenda item or the restricted agenda item is based on the current agenda item being a reoccurring agenda item that is part of a reoccurring communication session.

Example Clause N, the system of any one of Example Clauses J through L, wherein determining whether the current agenda item comprises the extendable agenda item or the restricted agenda item is based on a determination that an event associated with the current agenda item is scheduled to occur within a predetermined amount of time.

Example Clause O, the system of any one of Example Clauses J through N, wherein the instructions further cause the system to: determine that a topic being discussed during the time segment assigned to the current agenda item is not associated with the current agenda item; and add a new agenda item to the agenda, the new agenda item being associated with the topic.

Example Clause P, a system comprising: one or more processing units; and computer-readable media storing instructions that, when executed by the one or more processing units, cause the system to: access the agenda for the communication session, the agenda including a sequence of agenda items and a behavior-related goal intended to increase participation in the communication session; display information associated with the agenda and the behavior-related goal within a user interface that displays content of the communication session; collect data associated with participation in the communication session; analyze the data to determine that the behavior-related goal has not been satisfied; and generate a notification for display, the notification indicating that the behavior-related goal has not been satisfied.

Example Clause Q, the system of Example Clause P, wherein the behavior-related goal is automatically determined based on an analysis of one or more previous communication sessions.

Example Clause R, the system of Example Clause P or Example Clause Q, wherein the behavior-related goal is specific to a particular agenda item.

Example Clause S, the system of Example Clause P or Example Clause Q, wherein the behavior-related goal applies to each agenda item in the sequence of agenda items.

Example Clause T, the system of any one of Example Clauses P through S, wherein the notification is generated for display on a device of an organizer of the communication session.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

It should be appreciated that any reference to “first,” “second,” etc. users or other elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different users, two different computing devices, etc.).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter. All examples are provided for illustrative purposes and are not to be construed as limiting the scope of the claims.

1. A system for adapting an agenda during a communication session, the system comprising:
one or more processing units; and
computer-readable media storing instructions that, when executed by the one or more processing units, cause the system to:
access the agenda for the communication session, the agenda including a sequence of agenda items;
display information associated with the agenda within a user interface that displays content of the communication session, wherein the information includes at least one of a title of a current agenda item in the sequence of agenda items and an amount of time remaining in a time segment assigned to the current agenda item;
determine that a topic being discussed during the time segment assigned to the current agenda item is associated with another agenda item in the sequence of agenda items; and
adapt the agenda to produce an adapted agenda based on the determining that the topic being discussed during the time segment assigned to the current agenda item is associated with the other agenda item.

2. The system of claim 1, wherein the adapting the agenda to produce the adapted agenda comprises removing the other agenda item from the agenda.

3. The system of claim 1, wherein the adapting the agenda to produce the adapted agenda comprises moving the other agenda item to a position in the agenda that immediately follows the current agenda item.

4. The system of claim 1, wherein the adapting the agenda to produce the adapted agenda comprises:
extending the time segment assigned to the current agenda item; and
shortening a time segment assigned to the other agenda item.

5. The system of claim 1, wherein the adapting the agenda to produce the adapted agenda comprises switching a position of the current agenda item with a position of the other agenda item in the sequence of agenda items.

6. The system of claim 1, wherein the instructions further cause the system to:
request that an authorized person approve the adapted agenda; and
receive, based on input from the authorized person, approval of the adapted agenda, wherein the adapting the agenda to produce the adapted agenda is implemented based at least in part on the received approval.

7. The system of claim 1, wherein the instructions further cause the system to use the adapted agenda to automatically generate an initial agenda for a next communication session, the communication session and the next communication session being part of a re-occurring communication session.

8. The system of claim 1, wherein the instructions further cause the system to generate a summary of the communication session based on the adapted agenda.

9. The system of claim 1, wherein:
the agenda includes a break agenda item;
a time segment assigned to the break agenda item is determined based at least in part on a reason for a break; and
the break agenda item does not disclose the reason for the break thereby protecting privacy of one or more participants.

10. A system for adapting an agenda during a communication session, the system comprising:
one or more processing units; and
computer-readable media storing instructions that, when executed by the one or more processing units, cause the system to:
access the agenda for the communication session, the agenda including a sequence of agenda items;
determine that a predetermined amount of time remains for a time segment assigned to a current agenda item of the sequence of agenda items;
determine whether the current agenda item comprises an extendable agenda item or a restricted agenda item; and
cause a notification of the predetermined amount of time to be displayed, the notification indicating whether the current agenda item comprises the extendable agenda item or the restricted agenda item.

11. The system of claim 10, wherein the current agenda item is extendable and the instructions further cause the system to:
determine that an end of the time segment assigned to the current agenda item has been reached;
allow additional time for discussion of the current agenda item; and
adapt the agenda to account for the additional time.

12. The system of claim 11, wherein the adapting the agenda to account for the additional time comprises selecting another agenda item to shorten to ensure the communication session ends at a scheduled time, the other agenda item being associated with metadata indicating an ability to shorten the other agenda item.

13. The system of claim 10, wherein determining whether the current agenda item comprises the extendable agenda item or the restricted agenda item is based on the current agenda item being a reoccurring agenda item that is part of a reoccurring communication session.

14. The system of claim 10, wherein determining whether the current agenda item comprises the extendable agenda item or the restricted agenda item is based on a determination that an event associated with the current agenda item is scheduled to occur within a predetermined amount of time.

15. The system of claim 10, wherein the instructions further cause the system to:
determine that a topic being discussed during the time segment assigned to the current agenda item is not associated with the current agenda item; and
add a new agenda item to the agenda, the new agenda item being associated with the topic.

16. A system comprising:
one or more processing units; and
computer-readable media storing instructions that, when executed by the one or more processing units, cause the system to:
access the agenda for the communication session, the agenda including a sequence of agenda items and a behavior-related goal intended to increase participation in the communication session;
display information associated with the agenda and the behavior-related goal within a user interface that displays content of the communication session;
collect data associated with participation in the communication session;
analyze the data to determine that the behavior-related goal has not been satisfied; and
generate a notification for display, the notification indicating that the behavior-related goal has not been satisfied.

17. The system of claim 16, wherein the behavior-related goal is automatically determined based on an analysis of one or more previous communication sessions.

18. The system of claim 16, wherein the behavior-related goal is specific to a particular agenda item.

19. The system of claim 16, wherein the behavior-related goal applies to each agenda item in the sequence of agenda items.

20. The system of claim 16, wherein the notification is generated for display on a device of an organizer of the communication session.
